(19) United States
(12) Patent Application Publication
(10) Pub. No.: US 2015/0168435 A1
(43) Pub. Date: Jun. 18, 2015

(54) Automated Analyzer

(71) Applicant: JEOL Ltd., Tokyo (JP)

(72) Inventors: Takashi Yaginuma, Tokyo (JP); Masashi Yamada, Tokyo (JP)

(21) Appl. No.: 14/565,638

(22) Filed: Dec. 10, 2014

(30) Foreign Application Priority Data
Dec. 10, 2013 (JP) 2013-254877

(51) Int. Cl. G01N 35/04; G01N 35/02

(52) U.S. Cl. CPC G01N 35/04; G01N 35/025; G01N 2035/0484; G01N 2035/0465; G01N 2035/0453

(57) ABSTRACT

An automated analyzer (1) is offered which has a single mechanical drive (43) permitting a carrier arm member (31) to move in any one of two mutually perpendicular directions. The automated analyzer has a control rod (37), supported from the carrier arm member (31), supported from a holding or base mechanism (32). The holding mechanism (32) supports a movable frame (42), a mechanism body (41), a drive pulley (44), a driven pulley (45), the mechanical drive (43), a drive belt (46), and an arm holding member (47). The drive pulley (44) is rotatably mounted to the mechanism body (41). The driven pulley (45) is spaced a given spacing from the drive pulley (44) in a first direction (U1) and rotatably mounted to the mechanism body (41). The drive belt (46) is trained around both drive pulley (44) and driven pulley (45). The arm holding member (47) is formed on the drive belt (46) and rotatably mounted to the arm holding member (47).

### BACKGROUND OF THE INVENTION

1. Field of the Invention

The present invention relates to an automated analyzer for analyzing components of analytes by causing each analyte to react with a reagent and, more particularly, to a stirring bar or element that is inserted into and removed from a sample container or other reaction container and operative to perform an stirring operation, an injecting operation, and/or an aspirating operation and also to a drive mechanism for moving a control rod such as a probe.

2. Description of Related Art

A biochemical analyzer for analyzing various components contained in an analyte such as blood or urine is known as one type of automated analyzer. In this biochemical analyzer, a reagent corresponding to an item of analysis and an analyte are mixed and reacted with each other within a reaction container such as a cuvette. The biochemical analyzer analyzes a certain component of the analyte by converting photometric results of the reaction liquid into a concentration value.

In order to obtain high analytical accuracy from a biochemical analyzer, it is necessary to uniformly mix together an analyte and a reagent put in a reaction container. Therefore, the biochemical analyzer is fitted with a stirrer having a stirring rod or bar whose tip is inserted into a reaction container to perform stirring. This stirrer has a drive mechanism for moving the stirring rod from a standby position remote from the reaction container into a stirring position within the reaction container and for retracting the stirring rod into the standby position after the end of stirring.

In the above-described drive mechanism, when the stirring rod is moved from the reaction container into the standby position to prevent contact between the stirring rod and the reaction container, the stirring rod is once moved vertically upward and withdrawn from the reaction container. Then, the drive mechanism moves the stirring rod in a horizontal direction perpendicular to the vertical direction. On the other hand, when the stirring rod is moved from the standby position into the stirring position, the drive mechanism needs to perform a reverse operation, i.e., the mechanism lowers the stirring rod into the reaction container after the rod is moved horizontally to above the reaction container.

One example of a conventional stirrer for use in a biochemical analyzer is described by referring to FIG. 18, which schematically shows the configuration of the stirrer. Referring to FIG. 18, the stirrer is generally indicated by reference numeral 300 and has a stirring bar 301 being one example of a control rod, an arm member 302 supporting the stirring bar 301, a shaft pin 303 connected to the arm member 302, a guide portion 304 consisting of a frame boy for guiding the shaft pin 303, a drive shaft 305, and a crank arm 306. One end of the crank arm 306 is mounted to the drive shaft 305. A slot 307 extending longitudinally of the arm 306 is formed in the other end of the crank arm 306. The shaft pin 303 is slidably engaged in the slot 307 of the crank arm 306. The guide portion 304 is provided with a substantially U-shaped guide hole 304a. The shaft pin 303 engaged in the slot 307 is slidably engaged in the guide hole 304a.

In the stirrer 300, as the drive shaft 305 rotates, the crank arm 306 rotates in a clockwise direction as indicated by the arrows in FIG. 18 and moves from a position A1 into a position D1 through positions B1 and C1. As the crank arm 306 turns, the shaft pin 303 in engagement with the crank arm 306 moves along the guide hole 304a and is movable in the slot 307. Therefore, the shaft pin 303 moves while describing a U-shaped orbit along the guide hole 304a. In particular, during movement from the position A1 to the position B1, the shaft pin moves upward in a first direction U1. During movement from the position B1 to the position C1, the shaft pin moves in an arc because motion in a second direction R1 perpendicular to the first direction U1 is added. During movement from the position C1 to the position D1, the shaft pin moves in an arc downwardly in the first direction U1. Consequently, the arm member 302 connected to the shaft pin 303 moves while describing the same orbit as the shaft pin 303.

As a result, when the crank arm 306 has arrived at the position D1 and is at rest, the stirring bar 301 has moved into a location which is at the same height in the first direction U1 and shifted by an amount ΔH in the second direction R1 as compared with the state in which the crank arm 306 is located at the position A1. Furthermore, the stirring bar 301 can be moved between the two positions, i.e., stirring position and standby position, by rotationally driving the drive shaft 305 forwardly and rearwardly.

The automated analyzer set forth in JP-A-2009-25167 has a blade acting as a stirring element to move a probe for drawing in a reagent between a reagent container containing a reagent and a reaction container where the reagent and an analyte are reacted with each other. The blade rotates around the probe. The analyzer set forth in JP-A-2009-25167 has an arm rotating mechanism for moving the probe between the reagent container and the reaction container together with the blade. Furthermore, the analyzer has a vertical drive mechanism for moving an arm in an up-and-down direction.

The stirrer 300 shown in FIG. 18 has a single drive mechanism for moving the arm member in the first and second directions. However, in the stirrer 300 shown in FIG. 18, it is necessary to make bulky the crank arm that provides support of the arm member to permit the arm member to move large amounts in the first and second directions. This presents the problem that the whole apparatus is made large in size.

Furthermore, the stirrer 300 shown in FIG. 18 needs to have a gap between the shaft pin 303 and the guide hole 304a to permit the shaft pin 303 to slide smoothly in the guide hole 304a. Therefore, it may be conceivable to press the shaft pin 303 against the guide hole 304a by exerting a torque on the drive shaft 305 continuously while the shaft pin 303 is stopped at the positions A1 or D1. The positions A1 and D1 are the terminal positions of the guide hole 304a. If the shaft pin 303 is pressed against the guide hole 304a in this way, the stirrer is susceptible to the effects of vibrations from the outside due to the gap between the shaft pin 303 and the guide hole 304a. This presents the drawback that the stirring bar 301 is vibrated. The stirrer inserted in a cuvette at the stirring position may be brought into contact with the cuvette due to such vibrations, thus damaging the cuvette.

Furthermore, when the shaft pin moves in the guide hole, it is inevitable that rattling will be produced due to the aforementioned gap and that the stirring rod will vibrate.

If the stirring rod is less deeply inserted into the cuvette to prevent contact between the stirring rod and the cuvette at the stirring position due to vibrations, stirring done by the stirring rod functions unsatisfactorily. This has caused the automated analyzer to provide data of poor quality.

In addition, the drive mechanism of the automated analyzer set forth in JP-A-2009-25167 can intrinsically rotate and move the arm up and down to permit the probe to perform a drawing operation and a discharging operation. Therefore, the stirring rod held together with the probe can be moved between the two positions, i.e., stirring position and standby position. Accordingly, this drive mechanism can also be used to move the stirring rod into its two dedicated positions. In this case, however, it is necessary to provide two mechanical drives for rotation and vertical motion, respectively of the arm. This increases the number of components and leads to cost increases.

### SUMMARY OF THE INVENTION

In view of the foregoing problems, it is an object of the present invention to provide an automated analyzer using a single mechanical drive capable of moving a control rod between two positions by moving the rod in two mutually perpendicular directions. In a halt position, the analyzer is relatively immune to the effects of vibrations from the outside. Furthermore, while the control rod is in motion, lesser vibrations are produced.

In order to solve the foregoing problems and to achieve the above object, the automated analyzer of the present invention has a control rod, an arm member, and a holding mechanism. The control rod is inserted into and withdrawn from a sample container for holding a sample therein. The control rod is attached to the arm member. The arm member is held so as to be movable in a first direction in which the control rod is inserted into and withdrawn from the sample container and also in a second direction perpendicular to the first direction.

The holding mechanism has a movable frame, a mechanism body, a drive pulley, a driven pulley, a mechanical drive, an endless drive belt, and an arm holding portion. The arm member is supported by the movable frame so as to be movable only in one of the first and second directions. The movable frame is supported by the mechanism body so as to be movable only in the other of the first and second directions. The drive pulley is rotatably mounted to the mechanism body. The driven pulley is spaced a given spacing from the drive pulley in the first direction and rotatably mounted to the mechanism body. The mechanical drive rotationally drives the drive pulley forwardly and rearwardly. The drive belt is trained around the drive and driven pulleys. The arm holding portion is mounted on the drive belt and rotatably mounted to the arm member. The drive pulley and the driven pulley have their respective rotary shafts arranged to run parallel to a third direction perpendicular to the first and second directions.

In the automated analyzer of the structure described above, the arm holding portion mounted on the drive belt is mounted to the arm member and so the arm member moves with rotation of the drive belt. Consequently, the automated analyzer of the construction described above can move the arm member and the control rod in the two mutually perpendicular directions with the single mechanical drive.

The arm member is supported by the movable frame so as to be movable only in one of the first and second directions. Therefore, movement of the arm member relative to the movable frame is restricted to only one direction. The movable frame is supported by the mechanism body so as to be movable only in the other direction. Movement of the movable frame relative to the mechanism body is restricted to only one direction. That is, rotation of the arm member about the axial center of the arm holding portion is restricted. Therefore, when the arm member moves, less rattling occurs.

Another automated analyzer of the present invention has a control rod, an arm member, and a holding mechanism. The control rod is inserted into and withdrawn from a sample container for holding a sample therein. The control rod is attached to the arm member. The arm member is held by the holding mechanism so as to be movable in a first direction in which the control rod is inserted into and withdrawn from the sample container and also in a second direction perpendicular to the first direction.

The holding mechanism has a mechanism body, a drive pulley, a first driven pulley, a second driven pulley, a mechanical drive, a first endless drive belt, a second endless drive belt, a first arm holding portion, and a second arm holding portion. The drive pulley is rotatably mounted to the mechanism body. The first driven pulley is spaced a given spacing from the drive pulley in one sense of the first direction and rotatably mounted to the mechanism body. The second driven pulley is spaced a given spacing from the drive pulley in the other sense of the first direction and rotatably mounted to the mechanism body. The mechanical drive rotationally drives the drive pulley forwardly and rearwardly. The first drive belt is trained around the drive pulley and around the first driven pulley. The second drive belt is trained around the drive pulley and around the second driven pulley. The first arm holding portion is formed on the first drive belt and rotatably mounted to the arm member. The second arm holding member is formed on the second drive belt and rotatably mounted to the arm member with a given spacing from the first arm holding portion in the first direction. The drive pulley, first driven pulley, and second driven pulley have their respective rotary shafts which are arranged to run parallel to a third direction perpendicular to the first and second directions.

In the automated analyzer of the above-described construction, the arm member is supported at two points, i.e., the first and second arm holding portions. This restricts rotation of the arm member within a plane defined by the first and second directions and reduces rattling produced when the arm member moves. Also, in this automated analyzer, the arm member and the control rod can be moved in the two mutually perpendicular directions with the single mechanical drive.

According to the automated analyzer of the present invention, the single mechanical drive permits the arm member to be moved in the first direction and also in the second direction perpendicular to the first direction. The control rod can be moved between the two positions. Furthermore, vibrations produced when the arm member moves can be reduced. When the arm member is in its halt position, the arm member and the control rod can be rendered relatively immune to the effects of vibrations from the outside.

### BRIEF DESCRIPTION OF THE DRAWINGS

FIG. 1 is a schematic perspective view of a first embodiment of the automated analyzer of the present invention.

FIGS. 2 and 3 are perspective views of the stirrer of the automated analyzer shown in FIG. 1, showing different states.

FIG. 4 is an exploded perspective view of the stirrer shown in FIGS. 1-3.

FIG. 5 is a front elevation of the stirrer shown in FIGS. 2-4.

FIG. 6 is a side elevation of the stirrer shown in FIGS. 2-4.

FIG. 7 is a cross-sectional view of the stirrer shown in FIGS. 2-6, taken along line G-G of FIG. 5.

FIGS. 8A and 8B are perspective views of the arm holding member of the stirrer shown in FIG. 7.

FIGS. 9 and 10 are front elevations of the stirrer shown in FIGS. 2-7, illustrating the operation of the stirrer.

FIGS. 11A-11C schematically illustrate the operation of the stirrer shown in FIGS. 2-7.

FIG. 12 is a perspective view of a stirrer included in a second embodiment of the automated analyzer of the present invention.

FIG. 13 is a perspective view of the stirrer shown in FIG. 12.

FIG. 14 is an exploded perspective view of the stirrer shown in FIGS. 12 and 13.

FIG. 15 is a front elevation of the stirrer shown in FIGS. 12-14.

FIG. 16 is a cross-sectional view of the stirrer shown in FIGS. 12-15, taken on line T-T of FIG. 15.

FIGS. 17A-17C schematically illustrate the operation of the stirrer shown in FIGS. 12-16.

FIG. 18 is a schematic representation of a conventional stirrer for use in an automated analyzer.

### DESCRIPTION OF THE INVENTION

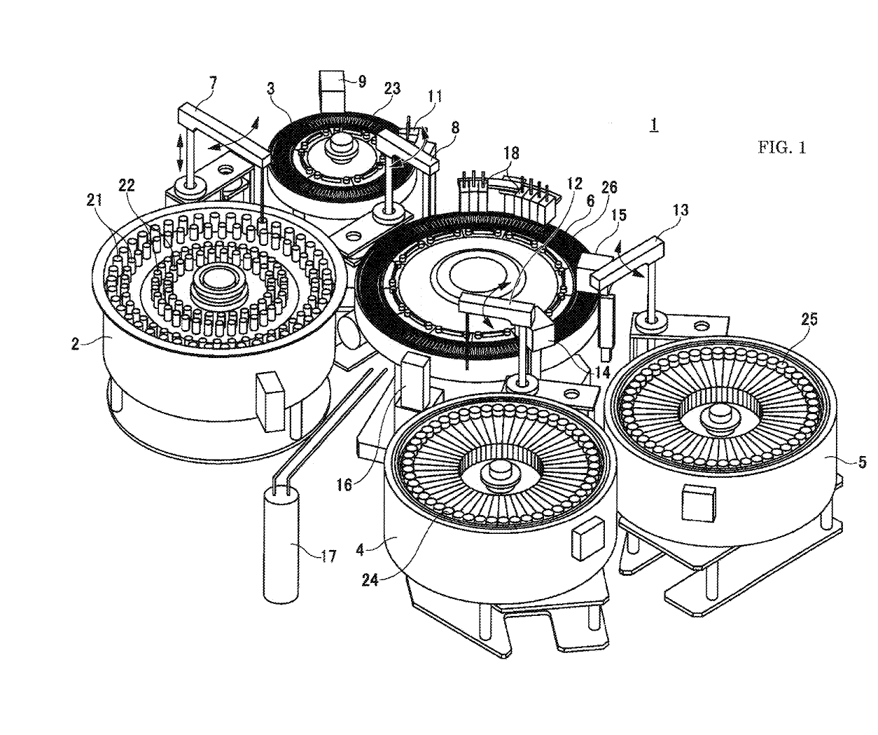

The preferred embodiments of the automated analyzer of the present invention are hereinafter described with reference to FIGS. 1-17, wherein common members are indicated by the same reference numerals. Note that the present invention is described in the order given below but the invention is not restricted to the following embodiments.

### 1. First Embodiment

### 1-1. Configuration of Automated Analyzer

### 1-2. Configuration of Stirrer

### 1-3. Operation of Stirrer

### 2. Second Embodiment

### 1. First Embodiment

### 1-1. Configuration of Automated Analyzer

A first embodiment of the automated analyzer of the present invention is first described by referring to FIG. 1, which schematically shows the analyzer.

The instrument shown in FIG. 1 is a biochemical analyzer, 1, employed as one example of the automated analyzer of the present invention. The biochemical analyzer 1 is an instrument for automatically measuring the amount of a certain component included in a biological sample such as blood or urine.

As shown in FIG. 1, the biochemical analyzer 1 has a sample turntable 2, a dilution turntable 3, a first reagent turntable 4, a second reagent turntable 5, and a reaction turntable 6. Furthermore, the analyzer 1 includes a sample diluting pipettor 7, a sampling pipettor 8, a diluting stirrer 9, a dilution cleaner 11, a first reagent pipettor 12, a second reagent pipettor 13, a first reaction stirrer 14, a second reaction stirrer 15, a multi-wavelength photometer 16, a thermostatic bath 17, and reaction container cleaners 18.

The sample turntable 2 is shaped like a container that is substantially cylindrical. One axial end of the cylindrical container is open. A plurality of analyte containers 21 and a plurality of diluting fluid containers 22 are received in the sample turntable 2. An analyte (sample) consisting of blood, urine, or the like is received in each analyte container 21. A special diluting fluid other than physiological salt solution that is a normal diluting fluid is received in each diluting fluid container 22.

The analyte containers 21 are spaced a given spacing from each other circumferentially of the sample turntable 2. The analyte containers 21 arranged circumferentially of the sample turntable 2 form two rows which are spaced a given amount from each other radially of the sample turntable 2.

The diluting fluid containers 22 are arranged inside of the rows of the analyte containers 21 as viewed radially of the sample turntable 2. The diluting fluid containers 22 are arranged at given intervals circumferentially of the sample turntable 2 in the same way as the analyte containers 21. The diluting liquid containers 22 arranged circumferentially of the sample turntable 2 form two rows which are spaced a given amount as viewed radially of the sample turntable 2.

The arrangement of the analyte containers 21 and the arrangement of the diluting fluid containers 22 are not each restricted to two rows. They may be one row or three or more rows spaced apart from each other radially of the sample turntable 2.

The sample turntable 2 is supported by a drive mechanism (not shown) so as to be rotatable circumferentially. The sample turntable 2 is circumferentially rotated at a given speed within each angular range by the drive mechanism (not shown). The dilution turntable 3 is arranged near the outer periphery of the sample turntable 2.

Each of the dilution turntable 3, first reagent turntable 4, second reagent turntable 5, and reaction turntable 6 is shaped like a cylindrical container whose axial one end is open in the same way as the sample turntable 2. The dilution turntable 3 and reaction turntable 6 are circumferentially rotated at a given speed within each angular range by drive mechanisms (not shown). The reaction turntable 6 is set to make more than a half revolution at a time.

A plurality of dilution containers 23 is arranged circumferentially of the dilution turntable 3 and received in the dilution turntable 3. Analytes drawn in from the analyte containers 21 arranged in the sample turntable 2 and diluted are received in the dilution containers 23.

A plurality of first reagent containers 24 is arranged circumferentially of the first reagent turntable 4 and received in the first reagent turntable 4. A plurality of second reagent containers 25 are arranged circumferentially of the second reagent turntable 5 and received in the second reagent turntable 5. A condensed first reagent is put in the first reagent containers 24. A condensed second reagent is put in the second reagent containers 25.

The first reagent turntable 4, first reagent containers 24, second reagent turntable 5, and second reagent container 25 are kept at a given temperature by a cold storage mechanism (not shown). Therefore, the first reagent received in the first reagent containers 24 and the second reagent received in the second reagent containers 25 are kept at the given low temperature.

The reaction turntable 6 is disposed among the dilution turntable 3, first reagent turntable 4, and second reagent turntable 5. A plurality of reaction containers 26 is arranged circumferentially of the reaction turntable 6 and received in the reaction turntable 6. A diluted analyte sampled from any one of the dilution containers 23 in the dilution turntable 3, the first reagent sampled from any one of the first reagent containers 24 in the first reagent turntable 4, and the second reagent sampled from any one of the second reagent containers 25 in the second reagent turntable 5 are injected into the reaction containers 26. In each of these reaction containers 26, the diluted analyte, first reagent, and second reagent are stirred together and reacted with each other.

The sample diluting pipettor 7 is disposed near the outer periphery of the sample turntable 2 and also near the outer periphery of the dilution turntable 3. The sample diluting pipettor 7 is supported by a diluting pipettor drive mechanism (not shown) so as to be movable axially of the sample turntable 2 and of the dilution turntable 3 (e.g., in the up-and-down direction). Furthermore, the sample diluting pipettor 7 is supported by the diluting pipettor drive mechanism so as to be rotatable along a horizontal direction that is substantially parallel to the openings of the sample turntable 2 and dilution turntable 3. The pipettor 7 reciprocates between the sample turntable 2 and the dilution turntable 3 by rotating in the horizontal direction. At this time, the pipettor 7 passes through a cleaner (not shown).

The operation of the sample diluting pipettor 7 is now described. When the pipettor 7 has moved into a given position located above the opening of the sample turntable 2, the pipettor 7 descends axially of the sample turntable 2, and its pipette tip is inserted into a selected one of the analyte containers 21. At this time, a sampling pump (not shown) is operated such that the pipettor 7 draws in a given amount of analyte from the analyte container 21. Then, the pipettor 7 ascends axially of the sample turntable 2 and pulls the pipette tip out of the analyte container 21. The pipettor 7 rotates horizontally and moves into a given position located above the opening of the dilution turntable 3.

Then, the sample diluting pipettor 7 descends axially of the dilution turntable 3 and inserts its pipette tip into a selected one of the dilution containers 23. The pipettor 7 dispenses the drawn analyte and a given amount of diluting fluid (e.g., physiological salt solution) supplied from the pipettor 7 itself into the dilution container 23. As a result, the analyte is diluted by a given factor within the dilution container 23. Then, the pipettor 7 is cleaned by the cleaner.

The sampling pipettor 8 is disposed between the dilution turntable 3 and the reaction turntable 6. The sampling pipettor 8 is supported by a sampling pipettor drive mechanism (not shown) so as to be movable axially (up-and-down direction) of the dilution turntable 3 and movable horizontally and rotatable in the same way as the sample diluting pipettor 7. The sampling pipettor 8 reciprocates between the dilution turntable 3 and the reaction turntable 6.

The sampling pipettor 8 inserts its pipette tip into a selected one of the dilution containers 23 in the dilution turntable 3 and aspirates a given amount of diluted analyte. Then, the sampling pipettor 8 dispenses the drawn diluted analyte into a selected one of the reaction containers 26 in the reaction turntable 6.

The first reagent pipettor 12 is disposed between the reaction turntable 6 and the first reagent turntable 4. The second reagent pipettor 13 is located between the reaction turntable 6 and the second reagent turntable 5. The first reagent pipettor 12 is supported by a first reagent pipettor drive mechanism (not shown) so as to be movable and rotatable axially (up-and-down direction) of the reaction turntable 6 and horizontally. The first reagent pipettor 12 reciprocates between the first reagent turntable 4 and the reaction turntable 6.

The first reagent pipettor 12 inserts its pipette tip into a selected one of the first reagent containers 24 in the first reagent turntable 4 and aspirates a given amount of first reagent. Then, the first reagent pipettor 12 dispenses the drawn first reagent into a selected one of the reaction containers 26 in the reaction turntable 6.

The second reagent pipettor 13 is supported by a second reagent pipettor drive mechanism (not shown) so as to be movable and rotatable axially (up-and-down direction) of the reaction turntable 6 and horizontally in the same way as the first reagent pipettor 12. The second reagent pipettor 13 reciprocates between the second reagent turntable 5 and the reaction turntable 6.

The second reagent pipettor 13 inserts its pipette tip into a selected one of the second reagent containers 25 in the second reagent turntable 5 and aspirates a given amount of second reagent. Then, the second reagent pipettor 13 dispenses the drawn second reagent into a selected one of the reaction containers 26 in the reaction turntable 6.

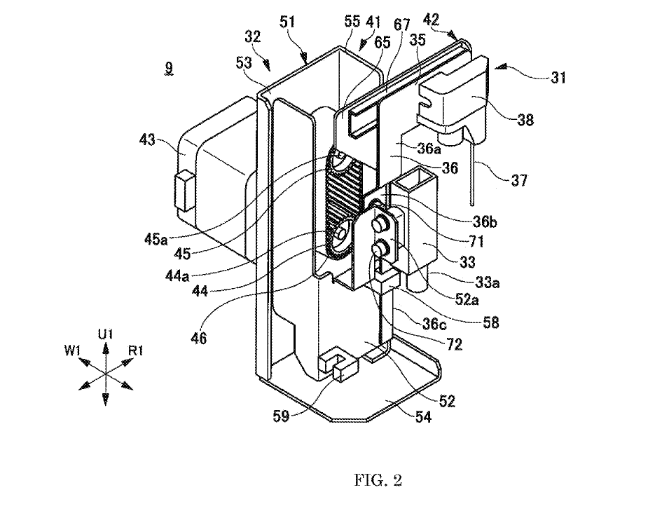

The diluting stirrer 9 and the dilution cleaner 11 are located near the outer periphery of the dilution turntable 3. The diluting stirrer 9 inserts a stirring bar 37 (see FIG. 2) described later into a selected one of the dilution containers 23 and stirs together the analyte and the diluting fluid. The configuration of the diluting stirrer 9 will be described in detail later.

The dilution cleaner 11 is a device for cleaning the dilution container 23 from which the diluted analyte has been drawn by the sampling pipettor 8. This cleaner 11 has a plurality of nozzles for cleaning dilution containers. These nozzles are connected with a waste fluid pump (not shown) and with a detergent pump (not shown). The dilution cleaner 11 inserts the dilution container cleaning nozzles into the dilution containers 23 and operates the waste fluid pump to aspirate the diluted analytes remaining in the dilution containers 23 by the inserted dilution container cleaning nozzles. The cleaner 11 then discharges the drawn diluted analytes into the waste fluid tank (not shown).

Subsequently, the dilution cleaner 11 supplies a detergent into the dilution container cleaning nozzles from the detergent pump and dispenses the detergent into the dilution containers 23 from the dilution container cleaning nozzles. The inside of each dilution container 23 is cleaned with this detergent. Then, the dilution cleaner 11 draws in a detergent by the dilution container cleaning nozzles and dries the inside of each dilution container 23.

The first reaction stirrer 14, second reaction stirrer 15, and reaction container cleaners 18 are disposed near the outer periphery of the reaction turntable 6. The first reaction stirrer 14 inserts a stirring rod or bar (not shown) into a selected one of the reaction containers 26 and stirs together the diluted analyte and the first reagent. Consequently, reaction between the diluted analyte and the first reagent is produced uniformly and quickly. Since the first reaction stirrer 14 is identical in configuration to the diluting stirrer 9, a description thereof is omitted here.

The second reaction stirrer 15 inserts the stirring bar (not shown) into a selected one of the reaction containers 26 and stirs together the diluted analyte, first reagent, and second reagent. As a consequence, reaction between the diluted analyte, first reagent, and second reagent is conducted uniformly and quickly. Since the second reaction stirrer 15 is identical in configuration to the diluting stirrer 9, a description thereof is omitted here.

Each of the reaction container cleaners 18 is a device for cleaning the inside of the reaction container 26 undergone testing. This cleaner 18 has a plurality of reaction container cleaning nozzles which are connected with the waste fluid pump (not shown) and with the detergent pump (not shown) in the same way as the dilution container cleaning nozzles. A step performed by the reaction container cleaner 18 to perform cleaning is similar to that performed by above-described dilution cleaner 11 and so a description thereof is omitted.

The multi-wavelength photometer 16 is disposed opposite to the outer peripheral wall of the reaction turntable 6. The photometer 16 is inserted into a selected one of the reaction containers 26, performs optical measurements of the diluted analyte which has reacted with the first and second reagents, outputs the amounts of various components of the analyte in terms of numerical data, known as absorbance, and detects how the diluted analyte has reacted.

The thermostatic bath 17 is disposed near the outer periphery of the reaction turntable 6. The thermostatic bath 17 is designed to maintain constant the temperature of the reaction containers 26 arranged in the reaction turntable 6 at all times.

### 1-2. Configuration of Stirrer

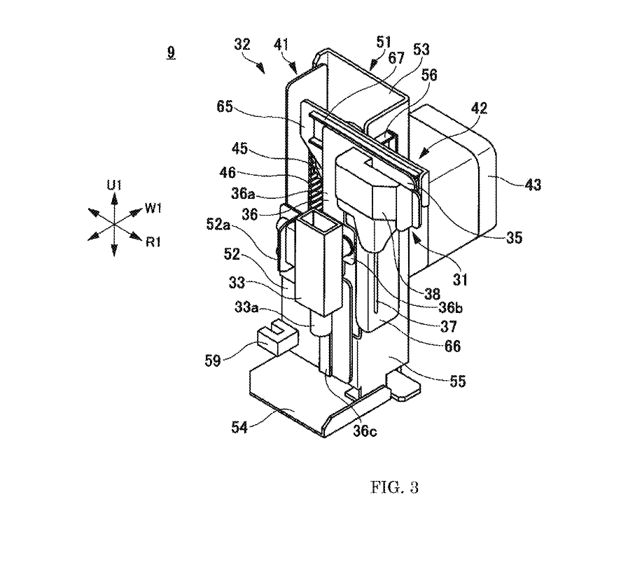

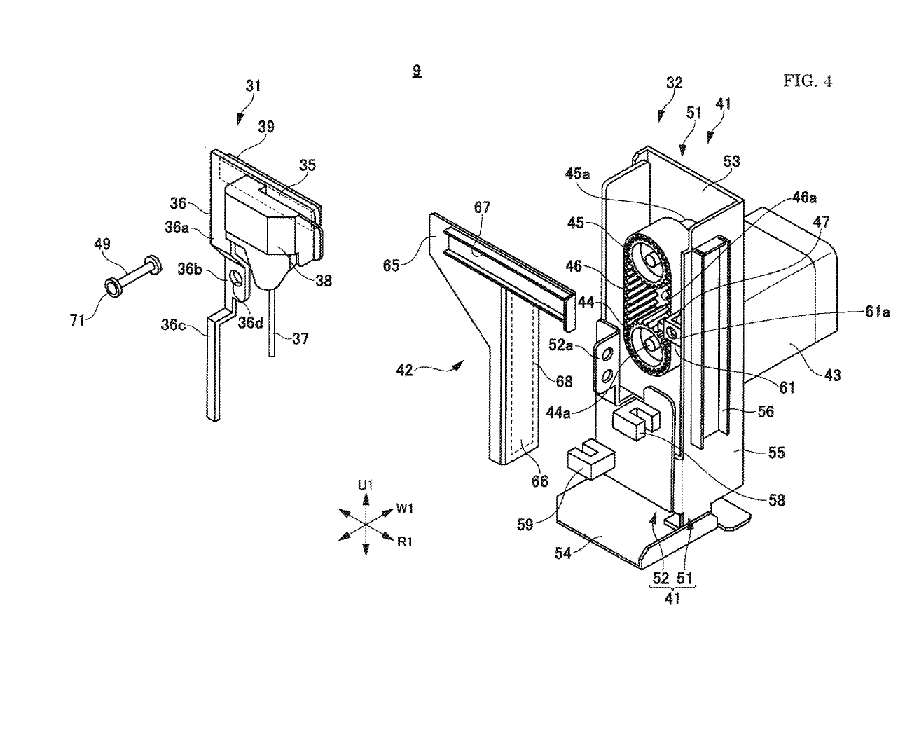

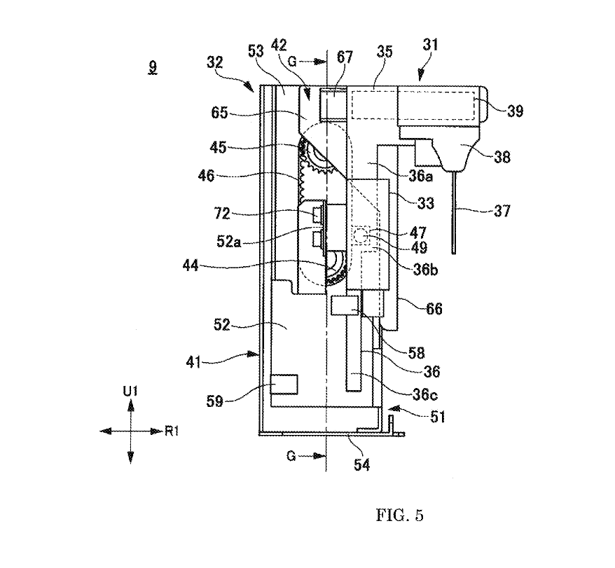

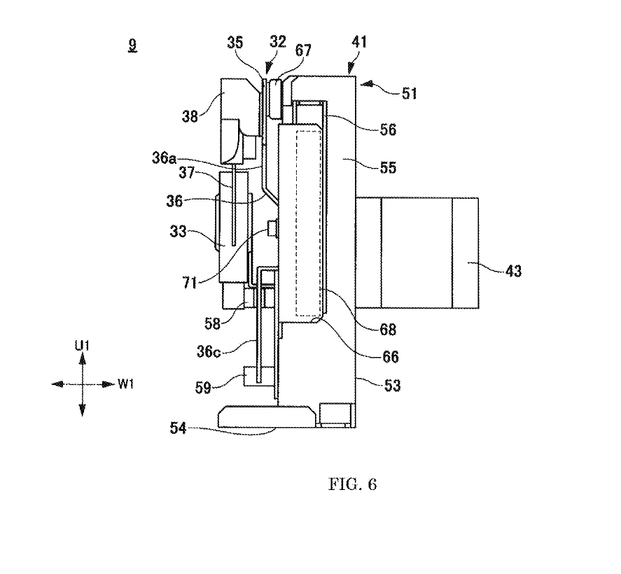

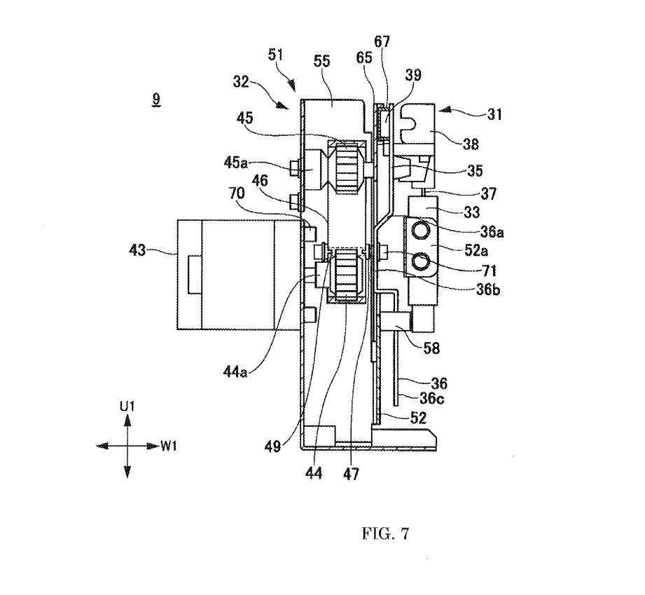

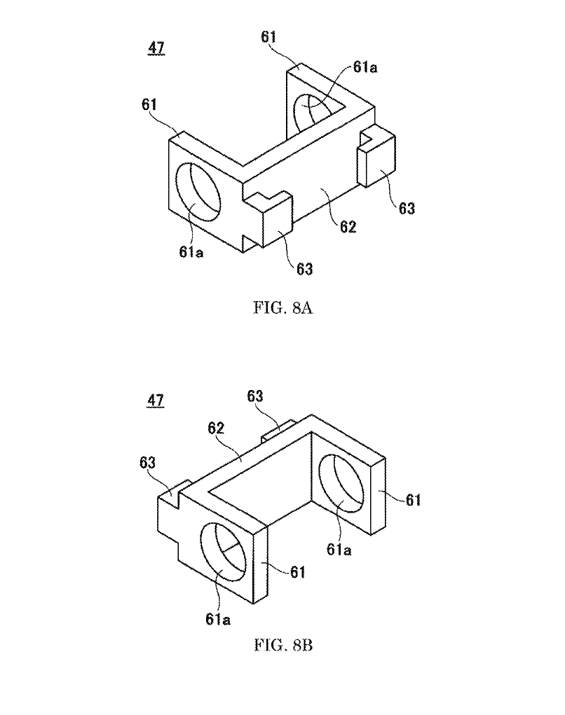

Details of the configuration of the diluting stirrer (hereinafter may be referred to simply as the stirrer) 9 are described next by referring to FIGS. 2-8. FIGS. 2 and 3 are perspective views of the stirrer 9. FIG. 4 is an exploded perspective view of the stirrer 9. FIG. 5 is a front elevation of the stirrer 9. FIG. 6 is a side elevation of the stirrer 9. FIG. 7 is a cross-sectional view taken on line G-G of FIG. 5. FIG. 8 is a perspective view of an arm holding member 47 (described later) of the stirrer 9. In FIG. 4, a cleaning port 33 (described later) is omitted from being shown.

As shown in FIGS. 2, 3, and 4, the stirrer 9 has an arm member 31 to which the stirring bar 37 is attached, a holding mechanism 32 by which the arm member 31 is movably held, and the cleaning port 33. The cleaning port 33 is shaped like a hollow container whose one side is open. The port 33 has a supply port (not shown) through which a cleaning liquid is supplied and a discharge port 33a from which used cleaning liquid is discharged. The cleaning port 33 operates to clean the stirring bar 37.

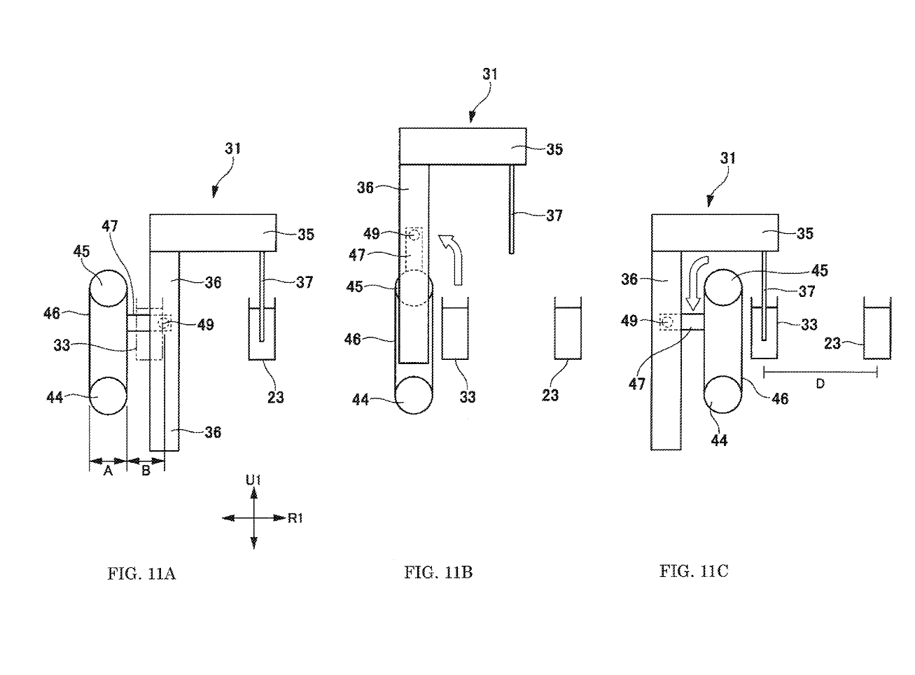

The stirring bar 37 attached to the arm member 31 is held by the holding mechanism 32 such that the arm member 31 can be moved in a first direction U1 in which the stirring bar 37 is inserted into and withdrawn from either the cleaning port 33 or the dilution container 23 that is one example of sample container of the present invention (see FIGS. 11A-11C). Furthermore, the arm member 31 is held by the holding mechanism 32 such that the arm member 31 can move in the second direction R1 which is perpendicular to the first direction U1 and in which the cleaning port 33 and the dilution container 23 are aligned.

In the present embodiment, the first direction U1 is substantially parallel to the vertical direction. The second direction R1 is substantially parallel to the horizontal direction. A direction perpendicular to both first direction U1 and second direction R1 is herein referred to as the third direction W1.

### Arm Member

As shown in FIG. 4, the arm member 31 is made of a plate-like member and shaped like the letter L. The arm member 31 is composed of a first flat plate portion 35 substantially in the form of a rectangle and a second flat plate portion 36 continuous with the first flat plate portion 35.

The longitudinal direction of the first flat plate portion 35 is substantially parallel to the second direction R1. The stirring bar 37 that is one example of the control rod of the present invention is attached to the surface of the first flat plate portion 35 located to one side of the third direction W1. The stirring bar 37 is placed on one side of the first flat plate portion 35 as viewed in the first direction U1 via a stirring mechanism 38.

The stirring mechanism 38 has a stirring drive mechanism (not shown). The stirring bar 37 is supported by the stirring mechanism 38 so as to be rotatable about its axis and movable within a given range in the second direction R1. The stirring bar 37 is inserted into the cleaning port 33 and into the dilution container 23 (see FIG. 11). The stirring bar 37 is rotated by the stirring mechanism 38 and reciprocated over a given distance in the second direction R1 to thereby stir together the analyte and diluting fluid put in the dilution container 23.

A second slider 39 slidably engaging with a second guide rail 67 (described later) is mounted on the other surface of the first flat plate portion 35. The second slider 39 is disposed substantially parallel to the second direction R1.

The second flat plate portion 36 is formed continuously from the other side of the first flat plat portion 35 as viewed in the second direction R1. The second flat plate portion 36 is shaped like a rectangle. The longitudinal direction of this rectangle is substantially parallel to the first direction U1. The second flat plate portion 36 has a connecting portion 36a connected with the first flat plate portion 35, a fixed portion 36b continuous with the connecting portion 36a, and a light blocking portion 36c continuous with the fixed portion 36b. The connecting portion 36a is located on one side of the second flat plate portion 36 as viewed in the first direction U1. The light blocking portion 36c is located on the other side of the second flat plate portion 36 as viewed in the first direction U1. The fixed portion 36b is located between the connecting portion 36a and the light blocking portion 36c.

The fixed portion 36b is a step surface that is recessed in a substantially parallel relation to the connecting portion 36a and light blocking portion 36c in the other sense of the third direction W1 from the connecting portion 36a and light blocking portion 36c. The fixed portion 36b is provided with a securing hole 36d through which a rotary shaft 49 passes, the shaft 49 being secured by a securing bolt 71.

### Holding Mechanism

The holding mechanism 32 is next described. The holding mechanism 32 has a mechanism body 41 consisting of a frame body, a movable frame 42, a mechanical drive 43, a drive pulley 44, a driven pulley 45, an endless drive belt 46, and the arm holding member 47 secured to the drive belt 46. The movable frame 42, mechanical drive 43, drive pulley 44, driven pulley 45, and drive belt 46 are mounted to the mechanism body 41.

The mechanism body 41 has a support member 51 and a mounting portion 52. The support member 51 is composed of a main flat portion 53, a placement surface portion 54, and a side surface portion 55. The support member 51 has a first guide rail 56.

The main flat portion 53 is shaped like a rectangle extending in the first direction U1. The placement surface portion 54 extends continuously from one end of the main flat portion 53 as viewed in the first direction U1 substantially vertically to the main flat portion 53. The placement surface portion 54 is shaped substantially rectangularly and fixedly placed in the body of the biochemical analyzer 1 (see FIG. 1).

The side surface portion 55 extends continuously from one end of the main flat portion 53 as viewed in the second direction R1 in a substantially vertical relation to the main flat portion 53. The side surface portion 55 is shaped like a rectangle extending in the first direction U1. The first guide rail 56 is secured on the side surface portion 55.

The mounting portion 52 is mounted opposite to the main flat portion 53 of the support member 51 in the third direction W1. The mounting portion 52 is located on one side of the main flat portion 53 as viewed in one sense of the third direction W1. The mounting portion 52 has a fixed portion 52a having securing screws 72 holding the cleaning port 33. The mounting portion 52 has a first sensor 58 and a second sensor 59.

The first sensor 58 is disposed on one side of the fixed portion 52a as viewed in the second direction R1. The second sensor 59 is located on one side the fixed portion 52a as viewed in the third direction W1. The first sensor 58 is a photo-interrupter having a light-emitting diode and a photodiode. The light-emitting diode and the photodiode are supported on a substantially U-shaped bracket secured on a sensor substrate, and are located opposite to each other.

The light-emitting diode emits a given amount of light at all times. If the photodiode receives light of less than the given amount, the output signal from the first sensor 58 goes High. On the other hand, if the light amount falling on the photodiode is less than the given amount of light, the output signal from the first sensor 58 goes Low.

The second sensor 59 is identical in configuration to the first sensor 58 and so a description of the second sensor 59 is omitted.

When the arm member 31 approaches one dilution container 23 and the stirring bar 37 is inserted in the dilution container 23, the light blocking portion 36c of the arm member 31 is inserted between the photodiode and the light-emitting diode of the first sensor 58 as shown in FIGS. 5 and 6. The light blocking portion 36c blocks the light emitted from the light-emitting diode of the first sensor 58. Consequently, insertion of the stirring bar 37 in the dilution container 23 can be detected.

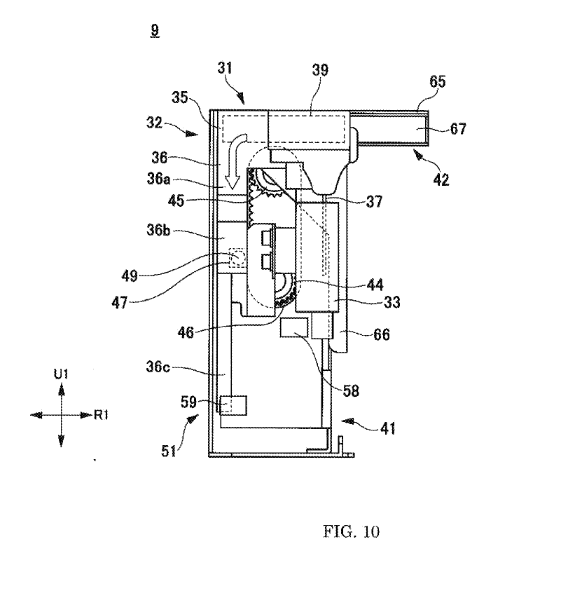

When the arm member 31 approaches the cleaning port 33 and the stirring bar 37 is inserted in the cleaning port 33, the light blocking portion 36c of the arm member 31 is inserted between the photodiode and the light-emitting diode of the second sensor 59 as shown in FIG. 10. The light blocking portion 36c blocks the light emitted from the light-emitting diode of the second sensor 59. Consequently, insertion of the stirring bar 37 in the cleaning port 33 can be detected.

As shown in FIG. 7, the drive pulley 44 and driven pulley 45 are rotatably mounted on one surface of the main flat portion 53 in one sense of the third direction W1. The drive pulley 44 and driven pulley 45 are appropriately spaced from each other in the first direction U1. The drive pulley 44 is located forwardly of the driven pulley 45 in the other sense of the first direction U1, i.e., located below the driven pulley 45. In the present embodiment, the drive pulley 44 and the driven pulley 45 are located rearwardly and forwardly, respectively, in the first direction U1. The invention is not restricted to this arrangement. For example, the drive pulley 44 and the driven pulley 45 may be located forwardly and rearwardly, respectively, in the first direction U1.

Each of the drive pulley 44 and driven pulley 45 has a plurality of teeth which are formed consecutively circumferentially and which protrude radially outwardly. The diameters of the drive pulley 44 and the driven pulley 45 are set to substantially identical values. The drive pulley 44 and the driven pulley 45 have rotary shafts 44a and 45a, respectively, which extend parallel to the third direction W1. The rotary shafts 44a, 45a of the drive pulley 44 and driven pulley 45 are at the same coordinate position in the second direction R1. The rotary shaft 44a of the drive pulley 44 extends fully from one surface to the other of the main flat portion 53.

The mechanical drive 43 is secured to the other surface of the main flat portion 53, i.e., the forward side of the main flat portion 53 in the other sense of the third direction W1, via securing screws 70. In the present embodiment, a stepping motor is used as the mechanical drive 43. The mechanical drive 43 is located at a position that is opposite to the drive pulley 44 with the main flat portion 53 therebetween. The mechanical drive 43 is coupled to the drive pulley 44 via the rotary shaft 44a.

As shown in FIGS. 2 and 4, the drive belt 46 is trained around both drive pulley 44 and driven pulley 45. The drive belt 46 has two straight portions which extend in the first direction U1 and are opposite to each other in the second direction R1. Furthermore, as mentioned previously, the drive pulley 44 and driven pulley 45 are substantially identical in diameter. The rotary shaft 44a of the drive pulley 44 and the rotary shaft 45a of the driven pulley 45 are so positioned that their coordinate positions in the second direction R1 are the same. Therefore, the straight portions of the drive belt 46 can be made substantially parallel to the first direction U1.

A plurality of protrusions 46a is formed on the inner wall surface of the drive belt 46 circumferentially of the inner wall surface. The protrusions 46a mate with the teeth of the drive pulley 44 and of the driven pulley 45. Consequently, when the drive pulley 44 and driven pulley 45 are at rest, it is possible to prevent the drive belt 46 from slipping relative to both drive pulley 44 and driven pulley 45. Thus, it is possible to prevent the drive belt 46 from rotating inadvertently. As shown in FIG. 4, the arm holding member 47 is securely fixed to the drive belt 46.

When the mechanical drive 43 operates, the drive pulley 44 rotates, thus rotating the drive belt 46 between the drive pulley 44 and the driven pulley 45. This causes the arm holding member 47 secured to the drive belt 46 to be moved between the drive pulley 44 and the driven pulley 45 together with the drive belt 46.

The arm holding member 47 is now described. As shown in FIGS. 8A and 8B, the arm holding member 47 being one example of the arm holding portion of the present invention has a pair of bearings 61, a connecting portion 62 interconnecting the bearings 61, and a pair of engaging pawls 63. The connecting portion 62 is shaped like a rectangle. The bearings 61 extend continuously from the longitudinal opposite ends of the connecting portion 62 in a substantially vertical relation to the connecting portion 62.

The bearings 61 of one pair are opposite to each other with the connecting portion 62 therebetween. The bearings 61 are provided with their respective bearing holes 61a. The rotary shaft 49 (FIG. 4) is rotatably fitted in the bearing holes 61a formed in the bearings 61. Consequently, the arm holding member 47 is rotatably mounted to the arm member 31 via the rotary shaft 49 as shown in FIGS. 5 and 7.

The engaging pawls 63 of one pair are mounted on the longitudinally opposite ends of the connecting portion 62. The engaging pawls 63 protrude from the opposite ends of the connecting portion 62 away from the bearings 61.

As shown in FIGS. 4 and 7, the arm holding member 47 is fixedly secured by engaging the engaging pawls 63 to the drive belt 46 and adhesively bonding, welding, or otherwise fastening the pawls to the belt. Therefore, the arm member 31 is mounted to the drive belt 46 while the arm holding member 47 is rotatably fitted.

In the present embodiment, an example has been given in which the arm holding member 47 is adhesively bonded or welded after the holding member 47 is engaged to the drive belt 46 by the engaging pawls 63 of one pair. The present invention is not restricted to this construction. For example, the engaging pawls of one pair may be eliminated from the arm holding member 47, and the connecting portion 62 may be directly adhesively bonded or welded to the outer surface of the drive belt 46.

In the present embodiment, an example has been given in which the arm holding member and the drive belt are made of separate members. The present invention is not restricted to this configuration. For instance, with respect to the arm holding member operative to hold the arm member, protrusions having bearing holes may be formed on the outer surface of the drive belt, and the drive belt and the arm holding member may be formed integrally.

The movable frame 42 is now described. As shown in FIG. 4, the movable frame 42 is made of a member in the form of a substantially flat plate having a bent portion. The movable frame 42 is composed of a guide support portion 65 and a sliding surface portion 66. Furthermore, the movable frame 42 has the aforementioned second guide rail 67 and a first slider 68.

The guide support portion 65 is shaped substantially rectangularly and extends in the second direction R1. The guide support portion 65 is opposite to the first flat plate portion 35 of the arm member 31 in the third direction W1. The second guide rail 67 is mounted on one surface of the guide support portion 65 that is opposite to the first flat plate portion 35.

The second guide rail 67 is arranged on the guide support portion 65 in a substantially parallel relation to the second direction R1. The second slider 39 mounted on the first flat plate portion 35 is slidably engaged to the second guide rail 67. Consequently, the arm member 31 is supported on the movable frame 42 so as to be movable in the second direction R1. Movement of the arm member 31 relative to the movable frame 42 in other than the second direction R1 is restricted.

The sliding surface portion 66 is shaped nearly rectangularly and extends in the first direction U1. As shown in FIGS. 3 and 6, the sliding surface portion 66 is opposite to the side surface portion 55 of the support member 51 in the second direction R1. The first slider 68 is mounted on the surface of the sliding surface portion 66 which is opposite to the side surface portion 55.

The first slider 68 is disposed substantially parallel to the first direction U1 on the sliding surface portion 66. The first slider 68 is slidably engaged to the first guide rail 56 mounted on the side surface portion 55. Consequently, the movable frame 42 is supported to the mechanism body 41 so as to be movable in the first direction U1. The movable frame 42 is suppressed from moving relative to the mechanism body 41 in other than the first direction U1. The movable frame 42 supports the arm member 31. Therefore, the arm member 31 is supported on the mechanism body 41 so as to be movable together with the movable frame 42 in the first direction U1.

The posture of the arm member 31 is kept unchanged at all times by the first guide rail 56 operative to guide movement in the first direction U1 and by the second guide rail 67 operative to guide movement in the second direction R1.

In the present embodiment, an example has been given in which the arm member 31 is supported by the movable frame 42 so as to be movable in the second direction R1 and the movable frame 42 is supported by the mechanism body 41 so as to be movable in the first direction U1. The present invention is not restricted to this configuration. For example, the arm member 31 may be supported by the movable frame 42 so as to be movable in the first direction U1 and the movable frame 42 may be supported by the mechanism body 41 so as to be movable in the second direction R1.

### 1-3. Operation of Stirrer

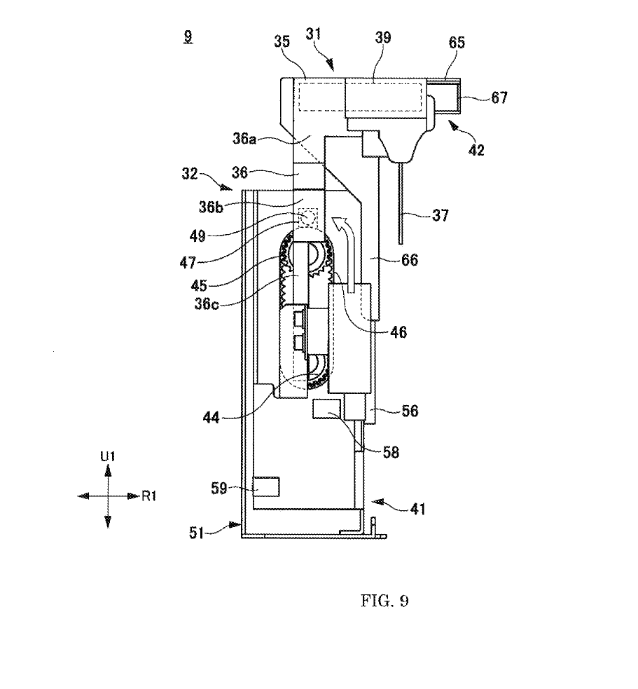

The operation of the stirrer 9 having the above-described configuration is next described by referring to FIGS. 5-7 and 9-11. FIGS. 9 and 10 are front elevations of the stirrer 9, illustrating its operation. FIGS. 11A-11C schematically illustrate the operation of the stirrer 9.

First, the operation of the stirrer 9 performed from the state in which the stirring bar 37 is inserted in the dilution container 23 until the stirring bar 37 is inserted into the cleaning port 33 as shown in FIGS. 5 and 11A is described.

When the stirring bar 37 is inserted in the dilution container 23 (see FIG. 11A), the light blocking portion 36c of the arm member 31 is inserted in the first sensor 58 as shown in FIG. 5. Light emitted from the light-emitting diode of the first sensor 58 is blocked by the light blocking portion 36c and so the stirring bar 37 can be detected to have been inserted in the dilution container 23.

Under the condition shown in FIGS. 5 and 11A, the mechanical drive 43 (see FIGS. 6 and 7) is operated. The rotating force of the mechanical drive 43 is transmitted to the drive pulley 44 via the rotary shaft 44a of the drive pulley 44. The drive pulley 44 is rotated in a counterclockwise direction as viewed in FIGS. 5 and 11A. The drive belt 46 rotates in the counterclockwise direction between the drive pulley 44 and the driven pulley 45.

Then, the arm holding member 47 secured to the drive belt 46 is moved in one sense of the first direction U1 (upward) along the rear straight portion of the drive belt 46 as viewed in the second direction R1. Furthermore, the arm member 31 mounted to the arm holding member 47 is moved together with the arm holding member 47 in one sense of the first direction U1 (upward) via the rotary shaft 49. The movable frame 42 is pushed against the arm member 31 via the second guide rail 67 and moved together with the arm member 31 in one sense of the first direction U1 (upward). As a result, as shown in FIG. 11B, the stirring bar 37 is withdrawn from the dilution container 23.

The straight portions of the drive belt 46 run substantially parallel to the first direction U1. Therefore, the stirring bar 37 can be withdrawn from the dilution container 23 exactly in the first direction U1, i.e., vertically upward.

Since the first slider 68 of the movable frame 42 slides on the first guide rail 56 of the support member 51, the arm member 31 can be moved in one sense of the first direction U1 (upward) without rattling. In consequence, the stirring bar 37 can be withdrawn from the dilution container 23 without resulting in contact between the stirring bar 37 and the dilution container 23.

When the drive pulley 44, driven pulley 45, and drive belt 46 rotate, the arm holding member 47 moves to above the driven pulley 45 in the first direction U1 circumferentially of the driven pulley 45 as shown in FIGS. 9 and 11B. The posture of the arm member 31 is maintained always by the second guide rail 67 and the first guide rail 56 via the movable frame 42. Therefore, when the arm holding member 47 passes the curved outer periphery of the driven pulley 45, the arm holding member 47 rotates about the rotary shaft 49 secured to the arm member 31 within a plane defined by the first direction U1 and the second direction R1.

Then, as shown in FIGS. 9 and 11B, the second slider 39 slides on the second guide rail 67. The arm member 31 moves in the other sense of the second direction R1. The stirring bar 37 mounted to the arm member 31 moves away from the dilution container 23 and approaches the cleaning port 33. The movable frame 42 is restricted from moving relative to the mechanism body 41 in other than the first direction U1. Consequently, only the arm member 31 is supported by the movable frame 42 and moves in the second direction R1.

Furthermore, when the drive pulley 44, driven pulley 45, and drive belt 46 rotate, the arm holding member 47 moves to the rear straight portion of the drive belt 46 as viewed in the second direction R1. At this time, the stirring bar 37 is located above the cleaning port 33 as viewed in the first direction U1.

Furthermore, when the drive pulley 44, driven pulley 45, and drive belt 46 rotate, the arm holding member 47 moves in the other sense of the first direction U1 (downward) along the rear straight portion of the drive belt 46 as viewed in the second direction R1 as shown in FIGS. 10 and 11C. Also, the arm member 31 and movable frame 42 move together with the arm holding member 47 in the other sense of the first direction U1 (downward).

The stirring bar 37 mounted to the arm member 31 is inserted into the cleaning port 33. This completes the operation of the stirrer 9 performed from the state in which the stirring bar 37 is inserted in the dilution container 23 as shown in FIGS. 5 and 11A until the stirring bar 37 is inserted into the cleaning port 33 as shown in FIGS. 10 and 11C.

When the stirring bar 37 is inserted from the cleaning port 33 into the dilution container 23, the drive pulley 44, driven pulley 45, and drive belt 46 are rotated in reverse to the foregoing direction. The sequence of operations is opposite to the above-described sequence of operations and so a description thereof is omitted.

Referring to FIG. 11A, let A be the diameter of the drive pulley 44 and of the driven pulley 45. Let B be the distance from the drive belt 46 to the axial center of the rotary shaft 49. The distance D that the arm member 31 and the stirring bar 37 can move in the second direction R1 can be found from the following Eq. (1):

D=A+2B (1)

It is possible to cope with the lengths of the cleaning port 33 and the dilution container 23 in the second direction R1 by varying the diameter of the drive pulley 44 and driven pulley 45 and/or the distance from the drive belt 46 to the axial center of the rotary shaft 49. That is, the distance D that the arm member 31 and the stirring bar 37 can move in the second direction R1 can be modified easily.

The distance that the arm member 31 and the stirring bar 37 can move in the first direction U1 can be set by the straight portions of the drive belt 46 and also by the radial dimensions of the drive pulley 44 and driven pulley 45. Therefore, the distance that the arm member 31 and the stirring bar 37 can move in the first direction U1 can be easily varied by changing the spacing between the first drive pulley 44 and the driven pulley 45 in the first direction U1 or the diameter of the drive pulley 44 and driven pulley 45.

In this way, the stirrer 9 of the present embodiment facilitates varying the distances that the arm member 31 and the stirring bar 37 can move in the first direction U1 and in the second direction R1 and, therefore, more latitude is allowed in installing the stirrer 9. Furthermore, the distances that the arm member 31 and the stirring bar 37 can move in the first direction U1 and in the second direction R1 can be varied according to apparatus and devices disposed around or beside the stirrer 9. This can alleviate the restrictions imposed on the shapes and sizes of the other apparatus and devices.

In the stirrer 9 of the present embodiment, the arm member 31 and the stirring bar 37 can be moved in two directions, i.e., the first direction U1 and the second direction R1, with the single mechanical drive 43 by moving the arm member 31 with rotation of the drive belt 46. Consequently, the number of mechanical drives can be reduced. Hence, cost reductions of the stirrer 9 can be achieved. Furthermore, since the number of mechanical drives can be reduced, troubles caused by defects of the mechanical drive can be reduced.

In addition, the arm member 31 is restricted from rotating about the central axis of the rotary shaft 49 by the second guide rail 67 that allows for movement in the second direction R1. Further, the movable frame 42 having the second guide rail 67 is restricted from moving in other than the first direction U1 by the first guide rail 56. Consequently, the posture of the arm member 31 can be maintained at all times, and rattling produced when the arm member 31 moves can be reduced. Additionally, when the stirring bar 37 is inserted in the cleaning portion 33 or dilution container 23, the arm member 31 can be made more immune to the effects of vibrations from the outside. As a result, the stirring bar 37 can be prevented from making contact with the cleaning port 33 and the dilution container 23.

### 2. Second Embodiment

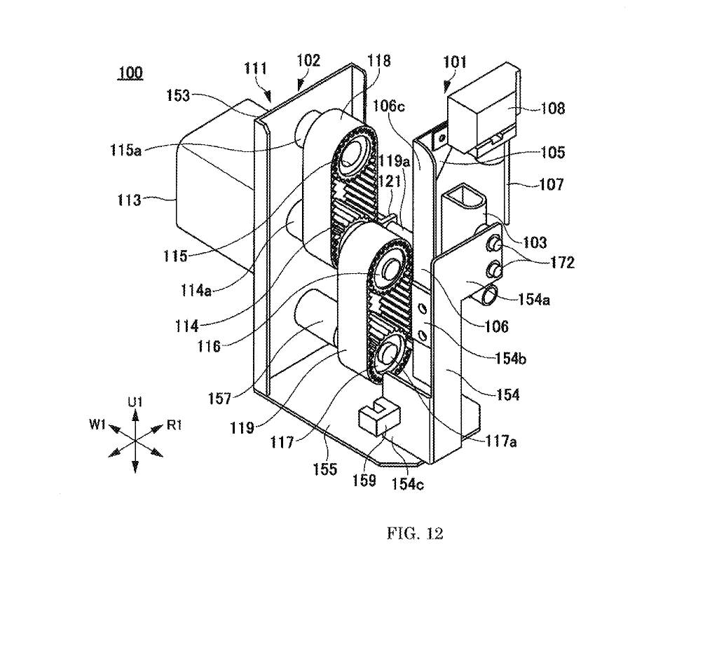

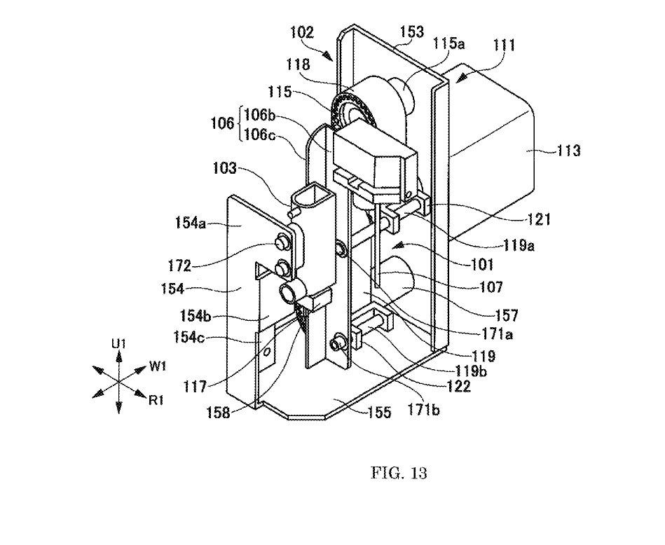

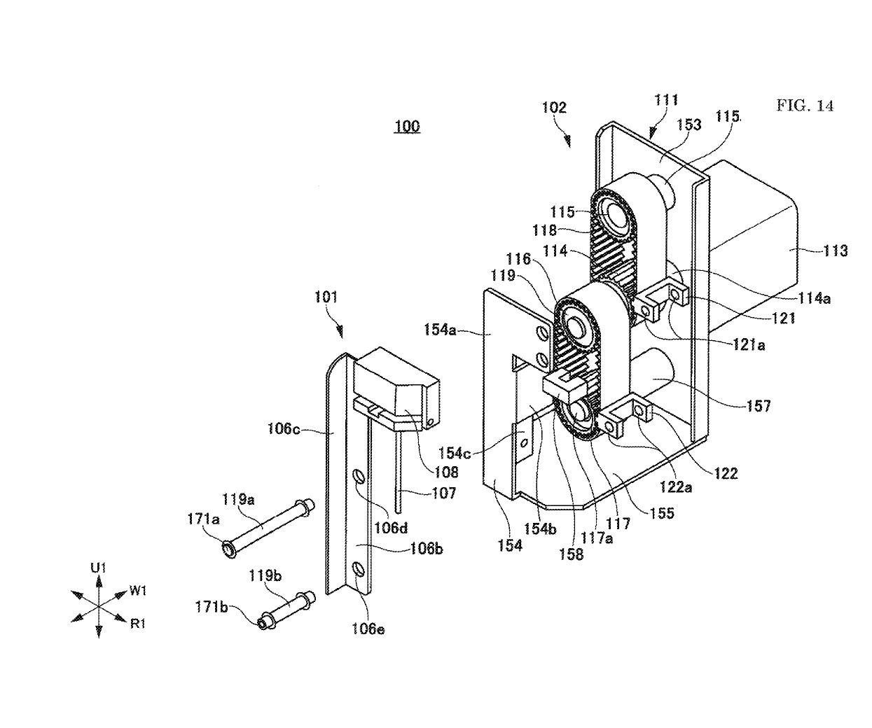

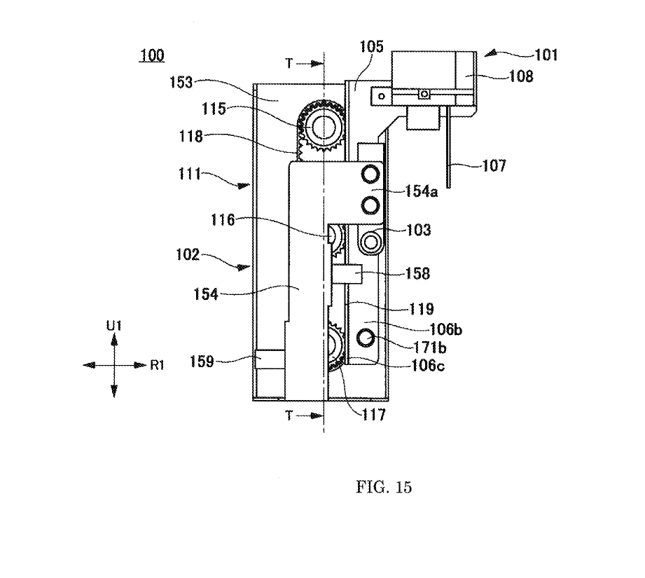

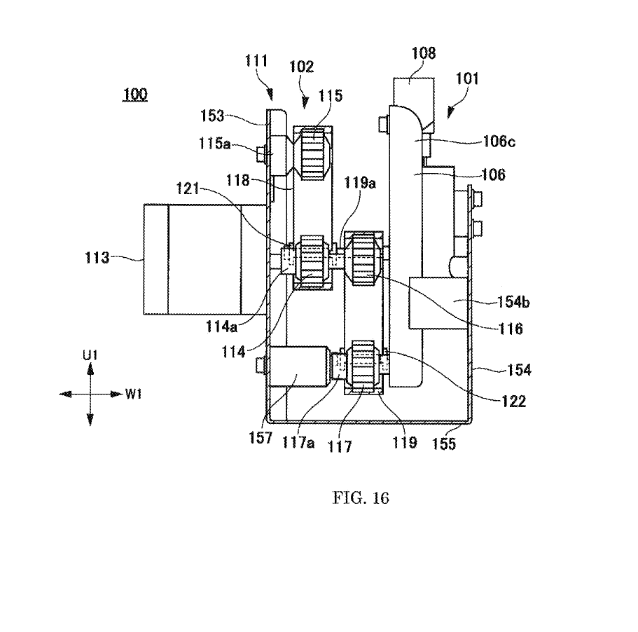

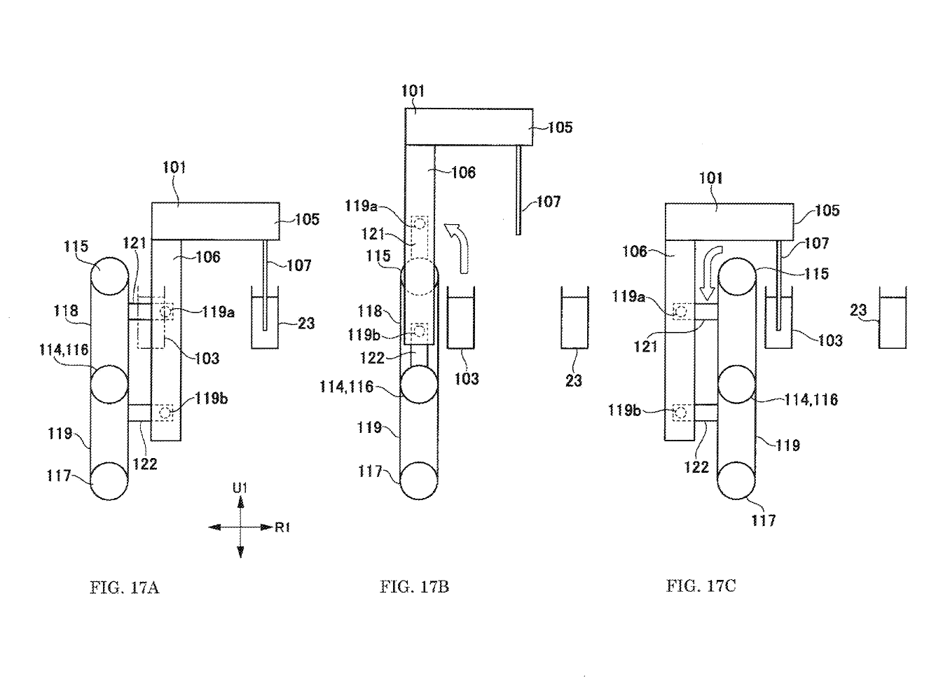

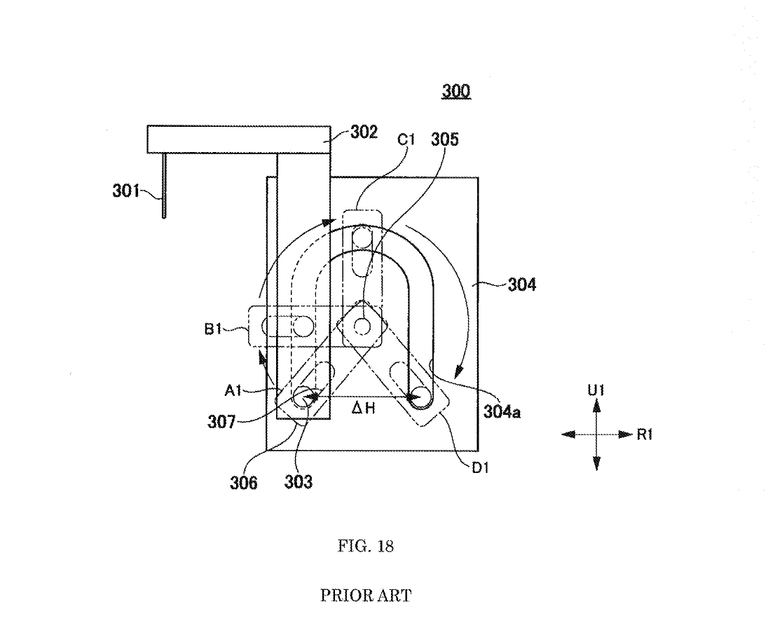

A second embodiment of the stirrer for use in the automated analyzer of the present invention is next described by referring to FIGS. 12-17. FIGS. 12 and 13 are perspective views of the second embodiment of the stirrer. FIG. 14 is an exploded perspective view of the second embodiment of the stirrer. FIG. 15 is a front elevation of the second embodiment of the stirrer. FIG. 16 is a cross-sectional view taken on line T-T of FIG. 15. FIGS. 17A-17C illustrate the operation of the second embodiment of the stirrer. In FIG. 14, the cleaning portion is omitted from being shown.

The stirrer associated with the second embodiment is generally indicated by reference numeral 100 and different from the stirrer 9 associated with the first embodiment in that the stirrer 100 has two drive belts, two arm holding members, and two rotary shafts. Those components of the stirrer 100 which are identical with their respective counterparts of the stirrer 9 are indicated by the same reference numerals as in the above cited figures and a repetition of the description thereof is omitted.

As shown in FIGS. 12-14, the stirrer 100 has an arm member 101, a holding mechanism 102 by which the arm member 101 is movably held, and a cleaning port 103. A stirring bar 107 is attached to the arm member 101. Also, in the stirrer 100 associated with the second embodiment, the arm member 101 is supported by the holding mechanism 102 so as to movable in the first direction U1 and in the second direction R1.

### Arm Member

The arm member 101 is composed of a first surface portion 105 to which the stirring bar 107 is mounted and a second surface portion 106 extending continuously from the first surface portion 105 in the first direction U1. The first surface portion 105 is shaped substantially rectangularly and extends in the second direction R1. The stirring bar 107 is mounted to the one surface of the first surface portion 105 in one sense of the third direction W1 via a stirring mechanism 108.

The cross section of the second surface portion 106 taken by a plane defined by the second direction R1 and the third direction W1 resembles the letter L. The second surface portion 106 is composed of a fixed portion 106b shaped nearly rectangularly and extending in the first direction U1 and a light blocking portion 106c extending continuously from one end of the fixed portion 106b in the second direction R1.

The fixed portion 106b is provided with a first fixed hole 106d and a second fixed hole 106e which are spaced a given spacing from each other in the first direction U1. The first fixed hole 106d is located on one side of the second fixed hole 106e in the first direction U1. A first rotary shaft 119a extends through the first fixed hole 106d and is secured by a securing bolt 171a. A second rotary shaft 119b extends through the second fixed hole 106e and is secured by a securing bolt 171b. The first rotary shaft 119a has an axial length set greater than the axial length of the second rotary shaft 119b.

### Holding Mechanism

The holding mechanism 102 is next described. The holding mechanism 102 has a mechanism body 111 made of a frame body, a mechanical drive 113, a first drive pulley 114, a first driven pulley 115, a second drive pulley 116, a second driven pulley 117, a first drive belt 118, and a second drive belt 119. Furthermore, the holding mechanism 102 has a first arm holding member 121 being one example of the first arm holding portion of the present invention and a second arm holding member 122 being one example of the second arm holding portion of the invention.

The mechanism body 111 is composed of a main surface portion 153, a mounting portion 154, and a placement surface portion 155. The main surface portion 153 is shaped substantially rectangularly and extends in the first direction U1. A spacer 157 is mounted to one end portion of the main surface portion 153 in the first direction U1. The spacer 157 protrudes a given distance from one surface of the main surface portion 153 in one sense of the third direction W1.

The mounting portion 154 is shaped substantially rectangularly and extends in the first direction U1. The mounting portion 154 is opposite to the main surface portion 153 in the third direction W1. The placement surface portion 155 extends continuously and substantially perpendicularly from their respective one ends of the main surface portion 153 and mounting portion 154 in the first direction U1.

The mounting portion 154 has a fixed portion 154a to which the cleaning port 103 is securedly fixed via securing screws 172. The mounting portion 154 is formed like the letter U and has a first sensor mounting part 154b and a second sensor mounting part 154c which are opposite to each other in the first direction U1. The first sensor mounting part 154b is located on one side of the second sensor mounting part 154c in the second direction R1. A first sensor 158 and a second sensor 159 are secured to the first and second sensor mounting parts 154b and 154c, respectively.

A first drive pulley 114 is rotatably mounted to one surface of the main surface portion 153 via a rotary shaft 114a. A first driven pulley 115 is rotatably mounted to this one surface of the main surface portion 153 via a rotary shaft 115a. The first drive pulley 114 and the first driven pulley 115 are appropriately spaced from each other in the first direction U1. The first drive pulley 114 is located rearwardly of the first driven pulley 115 in the first direction U1. The rotary shaft 114a of the first drive pulley 114 extends fully from one surface to the other of the main surface portion 153 and is coupled to the mechanical drive 113 at its rear end in the third direction W1.

The second drive pulley 116 is rotatably mounted to one side of the rotary shaft 114a of the first drive pulley 114 in the third direction W1. The second drive pulley 116 and second driven pulley 117 are appropriately spaced from each other in the first direction U1. The second driven pulley 117 is located rearwardly of the second drive pulley 116 in the first direction U1. The second driven pulley 117 is rotatably mounted to a spacer 157 via a rotary shaft 117a. The rotary shafts 114a, 115a, and 117a extend nearly parallel to the third direction W1.

The length of the spacer 157 taken in the third direction W1 is set substantially equal to the distance from the main surface portion 153 to the forward end of the first drive belt 118 in the third direction W1. The spacing between the first drive pulley 114 and the first driven pulley 115 in the first direction U1 is set substantially equal to the spacing between the second drive pulley 116 and the second driven pulley 117 in the first direction U1. The first drive pulley 114, first driven pulley 115, second drive pulley 116, and second driven pulley 117 are nearly equal in diameter.

The first drive belt 118 is trained around both first drive pulley 114 and first driven pulley 115. The second drive belt 119 is trained around both second drive pulley 116 and second driven pulley 117. Each of the first drive belt 118 and second drive belt 119 has two straight portions which run substantially parallel to the first direction U1 and which are opposite to each other in the second direction R1. The spacing between the two straight portions of the first drive belt 118 in the second direction R1 is set nearly equal to the spacing between the two straight portions of the second drive belt 119 in the second direction R1. The first drive belt 118 and the second drive belt 119 are substantially equal to each other in widthwise dimension.

Regarding the stirrer 100 associated with this second embodiment, an example has been given in which the stirrer has a drive pulley arrangement including the first drive pulley 114 and the second drive pulley 116. The invention is not restricted to this construction. For example, the first drive pulley 114 and the second drive pulley 116 may be coupled together in the third direction W1 to form one drive pulley assembly.

The first arm holding member 121 and the second arm holding member 122 are securely fixed to the first drive belt 118 and the second drive belt 119, respectively.

The first arm holding member 121 and the second arm holding member 122 protrude substantially vertically from the outer surfaces of the first drive belt 118 and second drive belt 119, respectively. The first arm holding member 121 and the second arm holding member 122 are arranged on the first drive belt 118 and second drive belt 119 at locations where the coordinate position of the first arm holding member 121 in the second direction R1 agrees with the coordinate position of the second arm holding member 122 in the second direction R2. The first arm holding member 121 and second arm holding member 122 protrude from the first drive belt 118 and second drive belt 119, respectively, in directions which are substantially parallel to each other.

The first arm holding member 121 is provided with first bearing holes 121a in which the first rotary shaft 119a fits. The second arm holding member 122 is provided with second bearing holes 122a in which the secondary rotary shaft 119b fits. Therefore, the first arm holding member 121 and second arm holding member 122 are rotatably mounted to the first rotary shaft 119a and second rotary shaft 119b, respectively.

The difference between the axial length of the first rotary shaft 119a and the axial length of the second rotary shaft 119b is set substantially equal to the difference between the spacing from the first arm holding member 121 to the arm member 101 in the third direction W1 and the spacing from the second drive belt 119 to the arm member 101 in the third direction W1.

The first rotary shaft 119a and second rotary shaft 119b are secured to the arm member 101 and so the arm member 101 is mounted to the first arm holding member 121 and second arm holding member 122 via the first rotary shaft 119a and second rotary shaft 119b, respectively. The first arm holding member 121 and second arm holding member 122 are rotatably supported to the fixed portion 106b of the arm member 101. That is, the arm member 101, first rotary shaft 119a, second rotary shaft 119b, first arm holding member 121, and second arm holding member 122 together constitute a parallel link mechanism.

The first arm holding member 121 and first drive belt 118 may be fabricated integrally. The second arm holding member 122 and second drive belt 119 may be fabricated integrally.

The arm member 101 is supported at two points, i.e., the first rotary shaft 119a and second rotary shaft 119b spaced a given amount from each other in the first direction U1 and held. Therefore, the first rotary shaft 119a and second rotary shaft 119b are restricted from rotating about their respective central axes.

The operation of the stirrer 100 associated with the second embodiment is next described by referring to FIGS. 17A-17C, which schematically illustrate the operation of the stirrer 100.

The operation of the stirrer 100 performed from the state in which the stirring bar 107 has been inserted in the dilution container 23 as shown in FIG. 17A until the stirring bar 107 is inserted into the cleaning port 103 is first described.

When the mechanical drive 113 (see FIG. 12) is operated, the resulting rotating force is transmitted to the first drive pulley 114 and second drive pulley 116 via the rotary shaft 114a of the first drive pulley 114 and second drive pulley 116. Under the condition shown in FIG. 17A, the first drive pulley 114 rotates in the counterclockwise direction, and the first drive pulley 118 rotates in the counterclockwise direction between the first drive pulley 114 and the first driven pulley 115. Similarly, the second drive pulley 116 rotates in the counterclockwise direction, and the second drive belt 119 rotates in the counterclockwise direction between the second drive pulley 116 and the second driven pulley 117.

Then, the first arm holding member 121 moves in one sense of the first direction U1 (upward) along the forward straight portion of the first drive belt 118 as viewed in the second direction R1. Similarly, the second arm holding portion 122 moves in one sense of the first direction U1 (upward) along the forward straight portion of the second drive belt 119 as viewed in the second direction R1.

The arm member 101 mounted to the first arm holding member 121 and to the second arm holding member 122 also moves in the first direction U1, thus pulling the stirring bar 107 out of the dilution container 23. The straight portions of the first drive belt 118 and second drive belt 119 extend substantially parallel to the first direction U1. The arm member 101 is supported at two points, i.e., the first rotary shaft 119a and second rotary shaft 119b, along the first direction U1. As a result, the posture of the arm member is maintained. Consequently, the stirring bar 37 can be pulled out of the dilution container 23 exactly in the first direction U1, i.e., vertically upward.

If the mechanical drive 113 is operated further and the first and second drive belts 118, 119 rotate, then the first arm holding member 121 moves to above the first driven pulley 115 in the first direction U1 along the outer surface of the first driven pulley 115 as shown in FIG. 17B. Similarly, the second arm holding member 122 moves to above the second drive pulley 116 in the first direction U1 along the outer surface of the second drive pulley 116.

The first arm holding member 121 passes the curved portion of the first driven pulley 115. At this time, the first arm holding member 121 rotates about the first rotary shaft 119a within a plane defined by the first and second directions U1 and R1. Similarly, the second arm holding member 122 rotates about the second rotary shaft 119b within a plane defined by the first and second directions U1 and R1. Consequently, the arm member 101 moves in the other sense of the second direction R1, and the stirring bar 107 moves away from the dilution container 23 and approaches the cleaning port 103.

As described previously, the arm member 101, first rotary shaft 119a, second rotary shaft 119b, first arm holding member 121, and second arm holding member 122 together constitute a parallel link mechanism. Therefore, when the first arm holding member 121 and the second arm holding member 122 pass the curved portions, the directions in which the first arm holding member 121 and second arm holding member 122 protrude from the first drive belt 118 and second drive belt 119, respectively, are kept parallel to each other at all times. Accordingly, when the first arm holding member 121 and second arm holding member 122 pass the curved portions, the posture of the arm member 101 is retained without tilting within the plane defined by the first and second directions U1 and R1.

If the mechanical drive 113 is operated further, the first arm holding member 121 and second arm holding member 122 move in the other sense of the first direction U1 (downward) along the rear straight portions of the first drive belt 118 and second drive belt 119 as viewed in the second direction R1 as shown in FIG. 17C. Therefore, the arm member 101 moves along with the first arm holding member 121 and second arm holding member 122 in the other sense of the first direction U1 (downward). As a result, the stirring bar 107 mounted on the arm member 101 is inserted into the cleaning port 103. In consequence, the operation of the stirrer 100 to move the stirrer 107 from the dilution container 23 to the cleaning port 103 is completed.

As described previously, the arm member 101 can be inserted and withdrawn straightly along the first direction U1. Therefore, vibrations of the arm member 101 produced during motion can be reduced. Furthermore, when the stirring bar 107 is inserted in the dilution container 23 or in the cleaning port 103, the arm member 101 can be made more immune to the effects of vibrations from the outside. The stirring bar 107 can be prevented from touching the dilution container 23 or the dilution port 103.

In other respects, the stirrer 100 associated with the second embodiment is similar to the stirrer 9 associated with the first embodiment and so a description of such similarities is omitted. The stirrer 100 of this configuration can yield advantageous effects similar to those produced by the stirrer 9 associated with the first embodiment.

It is to be understood that the present invention is not restricted to the embodiments set forth above and shown in various figures and that the invention can be implemented in various modified forms without departing from the gist of the invention set forth in the appended claims. For example, in the above embodiments, the inventive configuration is applied to a stirrer. The invention is not restricted to this application. The inventive configuration can be applied to a sample diluting pipettor, a sampling pipettor, a first reagent pipette, a second reagent pipette, and many other devices. That is, the inventive configuration can be applied to any device operative to move a control rod in a first direction that the rod is inserted into and withdrawn from a sample container and also in a second direction which is perpendicular to the first direction and in which the control rod is moved toward and away from the sample container.

The control rod of the present invention is not restricted to a stirring bar, a stirring rod, or a stirring element. Rather, the control rod can be any one of various types of control rod such as a pipette for aspirating and dispensing a sample. The mechanism for moving the control rod can be any type of mechanism for transferring the control rod between two positions. Furthermore, the sample container of the present invention for holding a sample therein is not restricted to the dilution container 23. The sample container of the invention can be applied to an analyte container for holding an analyte, a reaction container for causing an analyte and a reagent to react with each other, and various other sample containers.

In each of the above embodiments, the automated analyzer is a biochemical analyzer used for analysis of biological samples such as blood and urine. The automated analyzer is not restricted to such instruments. The automated analyzer can be applied to any other instrument that analyzes water quality, foods, and so on.

Having thus described our invention with the detail and particularity required by the Patent Laws, what is desired protected by Letters Patent is set forth in the following claims.

The invention claimed is:

1. An automated analyzer comprising:
a control rod inserted into and withdrawn from a sample container for holding a sample therein;
a carrier arm member to which the control rod is attached; and
a holding mechanism by which the arm member is held so as to be movable in a first direction in which the control rod is inserted into and withdrawn from the sample container and also in a second direction perpendicular to the first direction,
wherein said holding mechanism has:
a movable frame from which the arm member is supported so as to be movable only in one of the first and second directions;
a mechanism body from which the movable frame is supported so as to be movable only in the other of the first and second directions;
a drive pulley rotatably mounted to the mechanism body;
a driven pulley spaced a given spacing from the drive pulley in the first direction and rotatably mounted to the mechanism body;
a mechanical drive for rotationally driving the drive pulley forwardly and rearwardly;
an endless drive belt trained around the drive and driven pulleys; and
an arm holding portion mounted on the drive belt and rotatably mounted to the carrier arm member,
wherein the drive pulley and the driven pulley have their respective rotary shafts arranged to run parallel to a third direction perpendicular to the first and second directions.

2. The automated analyzer as set forth in claim 1, wherein said rotary shafts are securely fixed to the mechanism body, and wherein bearing portions are rotatably fitted over the rotary shafts.

3. The automated analyzer as set forth in claim 1, wherein said drive pulley and said driven pulley are set to substantially identical lengths.

4. The automated analyzer as set forth in claim 1, wherein the rotary shaft of said drive pulley and the rotary shaft of said driven pulley assume the same coordinate position in said second direction.

5. The automated analyzer as set forth in claim 1, wherein each of said drive pulley and said driven pulley has a plurality of teeth, and wherein said drive belt has an inner wall surface having a plurality of protrusions mating with the teeth.

6. The automated analyzer as set forth in claim 1, wherein the carrier arm member is slidably connected to the movable frame and the movable frame is slidably connected to the mechanism body.

7. The automated analyzer as set forth in claim 1, wherein said arm holding portion mounted on the belt drive moves from a position on one side of the pulley, to above the pulley, and to the other side of the pulley.

8. An automated analyzer comprising:
a control rod inserted into and withdrawn from a sample container for holding a sample therein;
a carrier arm member to which the control rod is attached; and
a holding mechanism by which the arm member is held so as to be movable in a first direction in which the control rod is inserted into and withdrawn from the sample container and also in a second direction perpendicular to the first direction,
wherein said holding mechanism has:
a mechanism body made of a frame body;
a drive pulley rotatably mounted to the mechanism body;
a first driven pulley spaced a given spacing from said drive pulley in one sense of the first direction and rotatably mounted to the mechanism body;
a second driven pulley spaced a given spacing from the drive pulley in the other sense of the first direction and rotatably mounted to the mechanism body;
a mechanical drive for rotationally driving the drive pulley forwardly and rearwardly;
a first endless drive belt trained around both the drive pulley and the first driven pulley;
a second endless drive belt trained around both the drive pulley and the second driven pulley;
a first arm holding portion formed on the first drive belt and rotatably mounted to the carrier arm member; and
a second arm holding portion formed on the second drive belt and rotatably mounted to the carrier arm member with a given spacing from the first arm holding portion in the first direction,
wherein said drive pulley, said first driven pulley, and said second driven pulley have their respective rotary shafts which are arranged to run parallel to a third direction perpendicular to the first and second directions.
